(19) United States
(12) Patent Application Publication
(10) Pub. No.: US 2025/0184669 A1
(43) Pub. Date: Jun. 5, 2025

(54) SOUND PRODUCTION DEVICE AND ELECTRONIC APPARATUS

(71) Applicant: GOERTEK INC., Weifang, Shandong (CN)

(72) Inventors: Xiaodong CAI, Weifang, Shandong (CN); Linlin ZHANG, Weifang, Shandong (CN); Xianzhong LANG, Weifang, Shandong (CN)

(21) Appl. No.: 18/843,358

(22) PCT Filed: Feb. 24, 2023
(86) PCT No.: PCT/CN2023/078102

§ 371 Date: Sep. 3, 2024

(30) Foreign Application Priority Data
Mar. 23, 2022 (CN) 202210290480.4

(51) Int. Cl. H04R 9/06; H04R 1/02; H04R 7/04; H04R 7/18; H04R 9/02; H04R 9/04

(52) U.S. Cl. CPC H04R 9/06; H04R 1/025; H04R 7/04; H04R 7/18; H04R 9/025; H04R 9/045; H04R 2400/11

(57) ABSTRACT

Disclosed are a sound production device and an electronic apparatus. The sound production device includes a housing, a vibration module, and a loudspeaker module; the housing is provided with a mounting cavity; the vibration module includes a coil and a vibrator assembly which are provided in the mounting cavity; the vibrator assembly is suspended in the mounting cavity and is arranged opposite the coil; the loudspeaker module includes a vibration system and a magnetic circuit system which are provided in the mounting cavity; the magnetic circuit system is provided on a side of the vibrator assembly facing away from the coil and is opposite the vibration system; wherein the coil drives the vibrator assembly to drive the magnetic circuit system to vibrate synchronously.

### TECHNICAL FIELD

The present disclosure relates to a technical field of electroacoustic conversion, and more particularly, to a sound production device and an electronic apparatus using the same.

### BACKGROUND

Electronic products and equipment, especially mobile phones, generally need to have both audio experience and vibration tactile experience functions, the audio experience comes from a loudspeaker device, and the vibration experience comes from a motor device. In the process of improving the user's audio experience and vibration tactile experience, the loudspeaker device and the motor device are provided separately in the relevant technology, resulting in problems such as large space occupation in smart terminal devices, unsatisfactory layout effect, etc., thereby affecting the user experience of the smart terminals.

### SUMMARY

A main object of the present disclosure is to provide a sound production device and an electronic apparatus, aiming to provide a sound production device that integrates a loudspeaker and a motor, so that the integration level of the sound production device can be improved, and the space occupied by the sound production device in an electronic apparatus is saved.

In order to achieve the above object, the present disclosure provides a sound production device including:
a housing provided with a mounting cavity;
a vibration module including a coil and a vibrator assembly which are provided in the mounting cavity, wherein the vibrator assembly is suspended in the mounting cavity and is arranged opposite the coil; and
a loudspeaker module including a vibration system and a magnetic circuit system which are provided in the mounting cavity, wherein the magnetic circuit system is provided on a side of the vibrator assembly facing away from the coil and is opposite the vibration system,
wherein the coil drives the vibrator assembly to drive the magnetic circuit system to vibrate synchronously.

In an embodiment, the vibrator assembly includes:
a vibrator body provided with a receiving groove corresponding to the coil, wherein at least a part of the coil is received in the receiving groove, and a side of the vibrator body facing away from the receiving groove is connected to the magnetic circuit system; and
an elastic member, one end of which is connected to the vibrator body, and the other end of which is connected to a cavity wall of the mounting cavity, so that the vibrator body is suspended in the mounting cavity.

In an embodiment, the vibrator body includes:
a counterweight base, opposite sides of which are respectively connected to the elastic member, wherein the counterweight base is provided with a hollow cavity corresponding to the coil, and the magnetic circuit system is connected to a side of the counterweight base facing away from the coil; and
a magnet assembly disposed in the hollow cavity and forming the receiving groove with the counterweight base, wherein the coil and the magnet assembly are disposed opposite each other.

In an embodiment, the elastic member includes two elastic sheets, which are symmetrically arranged on opposite sides of the vibrator body, wherein one end of each elastic sheet is connected to the vibrator body, and the other end thereof is connected to the cavity wall of the mounting cavity.

In an embodiment, the elastic sheet has a V-shape, a U-shape, a W-shape or a Y-shape; and/or,
an end of the elastic sheet away from the vibrator body is connected to the cavity wall of the mounting cavity through a connecting piece.

In an embodiment, the vibration system includes a diaphragm assembly and a voice coil connected to the diaphragm assembly, and a periphery of the diaphragm assembly is connected to the housing;
the magnetic circuit system includes a central magnetic circuit part and a side magnetic circuit part disposed on the vibrator assembly, wherein the side magnetic circuit part is arranged on the outside of the central magnetic circuit part and is spaced from the central magnetic circuit part to form a magnetic gap, and an end of the voice coil away from the diaphragm assembly is suspended in the magnetic gap.

In an embodiment, the side magnetic circuit part includes two side magnetic circuit parts, wherein the two side magnetic circuit parts are arranged on a longer axis side on both sides of the central magnetic circuit part, and a direction in which the magnetic gap formed by the two side magnetic circuit parts and the central magnetic circuit part extends is consistent with a vibration movement direction of the vibrator assembly; and/or,
the central magnetic circuit part includes a central magnet and a central washer arranged on the vibrator assembly, wherein the central washer is arranged on a side of the central magnet facing away from the vibrator assembly, and the side magnetic circuit part includes a side magnet and a side washer arranged on the vibrator assembly, wherein the side washer is arranged on a side of the side magnet facing away from the vibrator assembly, and
wherein a magnetization direction of the central magnet is opposite a magnetization direction of the side magnet.

In an embodiment, the housing includes a middle frame arranged at a periphery of the diaphragm assembly, and the diaphragm assembly includes:
a diaphragm including a central portion, a folded ring portion arranged around the central portion, and a fixing portion connected to the outside of the folded ring portion, the fixing portion being connected to an inner wall of the middle frame; and
a reinforcing member arranged on the central portion,
wherein the voice coil is connected to the central portion or the reinforcing member.

In an embodiment, the diaphragm and the reinforcing member are integrally injection molded; and/or,
the diaphragm and the middle frame are integrally injection molded; and/or,
the reinforcing member and the central portion are integrally formed by hot pressing; and/or,
one of the fixing portion or the inner wall of the middle frame is provided with a limiting boss, and the other thereof is provided with a limiting groove, and the limiting boss is limited in the limiting groove.

In an embodiment, the vibration system further includes a centering slice, wherein one end of the centering slice is connected to an end of the voice coil away from the diaphragm, and the other end of the centering slice is connected to the housing.

In an embodiment, a limiting stop is protruded from an inner wall of the housing, the limiting stop is directly opposite an edge of the reinforcing member, the limiting stop surrounds to form a via opening, and the voice coil passes through the via opening to be suspended in the magnetic gap.

In an embodiment, a conductive metal sheet is provided in the housing, wherein one end of the conductive metal sheet is provided with an inner pad, which is exposed to a side of the limiting stop facing away from the folded ring portion and soldered to the centering slice, and the other end of the conductive metal sheet is provided with an outer pad, which is exposed to an outer wall of the housing and connected to an external circuit.

The present disclosure also provides an electronic apparatus, including an apparatus housing and the above-mentioned sound production device, wherein the sound production device is disposed in the apparatus housing.

According to the sound production device provided by the present disclosure, a mounting cavity is provided in the housing, so that the mounting cavity is used to install, fix and protect the vibration module and the loudspeaker module, and the vibration module and the loudspeaker module are integrated into an integrated structure, so as to effectively improve the integration of the sound production device and save the space occupied by the sound production device in the electronic apparatus; meanwhile, a coil of the vibration module is disposed in the mounting cavity, and the vibrator assembly is suspended in the mounting cavity and is arranged opposite the coil, so that the coil can be used to drive the vibrator assembly to vibrate in the mounting cavity so as to realize the function of motor vibration, thereby enabling a vibration tactile experience function of the sound production device; further, the magnetic circuit system of the loudspeaker module is disposed on a side of the vibrator assembly facing away from the coil and is opposite the vibration system, so that on the one hand, the sound production function of the loudspeaker module is realized by the cooperation of the vibration system and the magnetic circuit system, and on the other hand, the coil is used to drive the vibrator assembly to drive the magnetic circuit system to vibrate synchronously, so that the vibration module and the loudspeaker module of the sound production device can work separately without interfering with each other, and accordingly, the sound production device has both audio experience and vibration tactile experience functions, which improves the user experience.

### BRIEF DESCRIPTION OF DRAWINGS

In order to more clearly illustrate the embodiments of the present disclosure or the technical solutions in the prior art, the drawings required to be used for the content of the embodiments or the prior art will be briefly introduced in the following. Obviously, the drawings in the following description are merely some embodiments of the present disclosure, and for those of ordinary skill in the art, other drawings can also be obtained from the provided drawings without any creative effort.

FIG. 1 is a schematic structural diagram of a sound production device according to an embodiment of the present disclosure;

FIG. 2 is a cross-sectional schematic diagram of a sound production device according to an embodiment of the present disclosure;

FIG. 3 is a cross-sectional schematic diagram of a sound production device in another perspective according to an embodiment of the present disclosure;

FIG. 4 is an exploded schematic diagram of a sound production device according to an embodiment of the present disclosure;

FIG. 5 is a schematic structural diagram of a housing according to an embodiment of the present disclosure;

FIG. 6 is a partial cross-sectional schematic diagram of a diaphragm assembly according to an embodiment of the present disclosure.

Explanation of Reference Numerals

| Numeral | Name | Numeral | Name |
|---|---|---|---|
| 100 | sound production device | 3 | loudspeaker module |
| 1 | housing | 31 | vibration system |
| 11 | mounting cavity | 311 | diaphragm assembly |
| 12 | limiting slot | 3112 | limiting groove |
| 13 | limiting stop | 3113 | limiting post |
| 14 | via opening | 3114 | diaphragm |
| 15 | conductive metal sheet | 3115 | central portion |
| 151 | inner pad | 3116 | folded ring portion |
| 152 | outer pad | 3117 | fixing portion |
| 16 | middle frame | 3118 | limiting boss |
| 2 | vibration module | 3119 | reinforcing member |
| 21 | coil | 312 | voice coil |
| 22 | vibrator assembly | 313 | centering slice |
| 221 | vibrator body | 32 | magnetic circuit |
| | | | system |
| 2211 | receiving groove | 321 | central magnetic |
| | | | circuit part |
| 2212 | counterweight base | 3211 | central magnet |
| 2213 | hollow cavity | 3212 | central washer |
| 2214 | magnet assembly | 322 | side magnetic circuit |
| | | | part |
| 2215 | magnet block | 3221 | side magnet |
| 222 | elastic member | 3222 | side washer |
| 2221 | elastic sheet | 323 | magnetic gap |
| 2222 | connecting piece | 4 | front cover |
| 23 | circuit board | | |

The realization of the purpose, functional features and advantages of the present application will be further explained in conjunction with embodiments and with reference to the accompanying drawings.

### DETAILED DESCRIPTIONS

Technical solutions of embodiments of the present application will be described clearly and completely below with reference to the drawings in the embodiments of the present application. Obviously, the described embodiments are only a part of the embodiments of the present application, rather than all the embodiments. Based on the embodiments in the present application, all other embodiments obtained by those of ordinary skill in the art without creative efforts shall fall within the protection scope of the present application.

It should be noted that all the directional indications (such as up, down, left, right, front, back . . . ) in the embodiments of the present application are only used to explain the relative position relationship, movement status, etc. between the components under a certain specific posture (as shown in the drawings), and if the specific posture changes, the directional indications will also change accordingly.

In addition, the meaning of “and/or” herein includes three parallel schemes. For example, the meaning of “A and/or B” includes a scheme A, a scheme B, or a scheme of both A and B.

In addition, “first”, “second”, etc. in the present disclosure are only for descriptive purposes, and should not be construed as indicating or implying their relative importance or implicitly indicating the quantity of indicated technical features. Thus, the features defined with “first”, “second”, etc. may explicitly or implicitly include at least one of these features. In addition, the technical solutions of various embodiments of the present disclosure can be combined with each other, but it should be based on the fact that the technical solutions can be realized by those skilled in the art. When the combination of technical solutions is contradictory or cannot be realized, it should be considered that the combination does not exist and is not within the scope of protection required by the present disclosure.

Electronic products and equipment, especially mobile phones, generally need to have both audio experience and vibration tactile experience functions, the audio experience comes from a loudspeaker device, and the vibration experience comes from a motor device. In the process of improving the user's audio experience and vibration tactile experience, the loudspeaker device and the motor device are provided separately in the relevant technology, resulting in problems such as large space occupation in smart terminal devices, unsatisfactory layout effect, etc., thereby affecting the user experience of the smart terminals.

It will be understood that in some smart wearable devices, in a case that the spatial size of the whole device is limited, if the loudspeaker and vibration motor functions can be combined, a lot of space for the whole device may be saved. Based on the above concepts and problems, the present disclosure proposes a sound production device 100. The sound production device 100 may be applied to electronic apparatus, such as mobile phones, wearable devices, etc., which will be not limited here.

In the present disclosure, the sound production device 100 functionally integrates the loudspeaker and the vibration motor, which is not just a combination of the topological structures of two functional products, but uses magnetic circuit components coupled together, so that the spatial size of the integrated product is much smaller than the simple sum of the volumes of the two. It will be understood that the sound production device 100 of the present disclosure couples the functions of the loudspeaker and the vibration motor together, which can realize both the sound production function of the loudspeaker and the vibration function of the vibration motor, and the magnetic circuit component for realizing the loudspeaker function in the product structure is also the vibrator that realizes the vibration motor function.

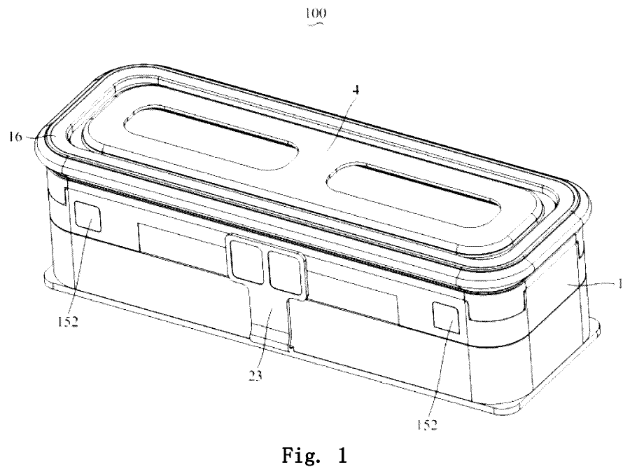

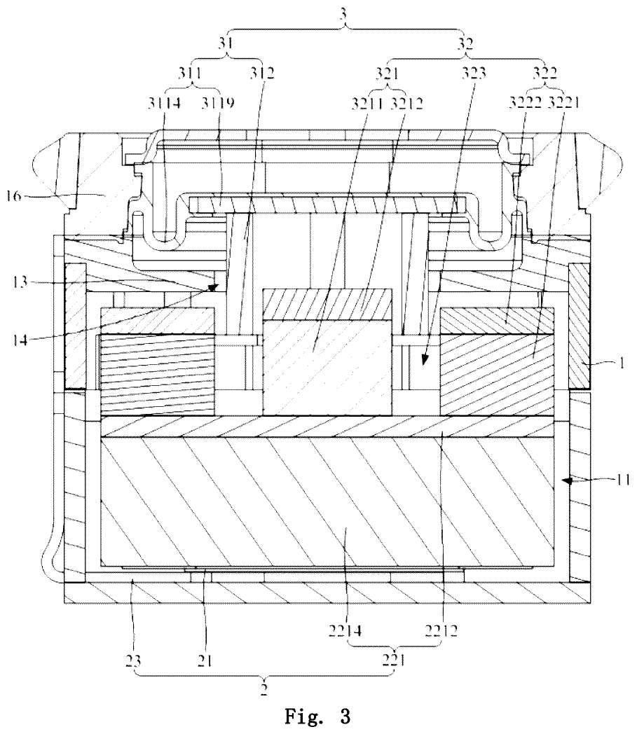

Referring to FIGS. 1-4 together, in an embodiment of the present disclosure, the sound production device 100 includes a housing 1, a vibration module 2 and a loudspeaker module 3. The housing 1 is provided with a mounting cavity 11, the vibration module 2 includes a coil 21 and a vibrator assembly 22 arranged in the mounting cavity 11, the vibrator assembly 22 is suspended in the mounting cavity 11 and is arranged opposite the coil 21, the loudspeaker module 3 includes a vibration system 31 and a magnetic circuit system 32 arranged in the mounting cavity 11, the magnetic circuit system 32 is arranged on a side of the vibrator assembly 22 facing away from the coil 21 and is opposite the vibration system 31. The coil 21 drives the vibrator assembly 22 to drive the magnetic circuit system 32 to vibrate synchronously.

In the embodiment, the housing 1 of the sound production device 100 is used to install, fix and support components such as the vibration module 2 and the loudspeaker module 3, that is, the housing 1 provides an installation base for components such as the vibration module 2 and the loudspeaker module 3. In order to facilitate the installation of and protect components such as the vibration module 2 and the loudspeaker module 3, the housing 1 has a mounting cavity 11. Optionally, the structure of the housing 1 may be a mounting shell, a box, a cabinet, or the like having a mounting cavity 11.

It will be understood that the housing 1 may have an integrated structure or a split structure. As shown in FIGS. 1-4, the housing 1 includes a first housing and a second housing, that is, the housing 1 is provided in a split structure, and the first housing and the second housing are connected to form an integrated structure. Of course, in other embodiments, the housing 1 may also be formed in an integrated molding method, which is not limited here.

Optionally, the first housing and the second housing of the housing 1 are both metal parts, and the first housing and the second housing are sealed to define the mounting cavity 11. That is, the first housing and the second housing are made of metal materials, so that the overall structure of the housing 1 is made of metal materials.

It will be understood that the first housing and the second housing of the housing 1 may be made of thinner steel sheets, so that the housing 1 can be designed to be thinner, thereby greatly increasing the volume of cavity inside the housing 1, effectively increasing the volume of the vibration module 2 and the loudspeaker module 3 in the mounting cavity 11, and thus improving the acoustic performance of the sound production device 100. Meanwhile, the loudspeaker module 3 is fixed in the housing 1, so that heat dissipation can be achieved through the housing 1 made of metal materials, thereby improving the heat dissipation performance of the sound production device 100.

In the embodiment, the vibration module 2 includes a coil 21 and a vibrator assembly 22. The vibrator assembly 22 is suspended in the mounting cavity 11 and is arranged opposite the coil 21, so that after the current flows through the coil 21, the coil 21 can drive the vibrator assembly 22 to vibrate in the mounting cavity 11 to realize the motor function, and as a result, the sound production device 100 also has a vibration experience function. It will be understood that the loudspeaker module 3 may be a sound production unit, and the loudspeaker module 3 includes a vibration system 31 and a magnetic circuit system 32, so as to achieve sound generation by utilizing a coupling structure of vibration system 31 and magnetic circuit system 32, and as a result, the sound production device 100 also has an audio experience function.

It will be understood that by providing the magnetic circuit system 32 on the side of the vibrator assembly 22 facing away from the coil 21 and opposite the vibration system 31, when the coil 21 drives the vibrator assembly 22 to vibrate, it also drives the magnetic circuit system 32 to vibrate synchronously, so that the sound production device 100 not only integrates the vibration module 2 and the loudspeaker module 3, integrating the topological structures of the two functional products of vibration experience function and audio experience function, but also couples the magnetic circuit system 32 of the loudspeaker module 3 to the vibrator assembly 22 of the vibration module 2, thereby effectively reducing the volume of the integrated sound production device 100, that is, the spatial size of the integrated sound production device 100 is much smaller than the simple sum of the volumes of the vibration module 2 and the loudspeaker module 3. Meanwhile, when realizing the function of the loudspeaker module 3, the magnetic circuit system 32 in the loudspeaker module 3 is also a part for realizing the vibration of the vibrator assembly 22 in the vibration module 2, and can realize the simultaneous operation of functions of the vibration module 2 and the loudspeaker module 3.

The sound production device 100 of the present disclosure is provided with a mounting cavity 11 in the housing 1, so that the mounting cavity 11 is used to install, fix and protect the vibration module 2 and the loudspeaker module 3, and the vibration module 2 and the loudspeaker module 3 are integrated into an integrated structure, thereby effectively improving the integration degree of the sound production device 100 and saving the space occupied by the sound production device 100 in electronic apparatus. Meanwhile, the coil 21 of the vibration module 2 is disposed in the mounting cavity 11, and the vibrator assembly 22 is suspended in the mounting cavity 11 and is opposite the coil 21, so that the coil 21 can be used to drive the vibrator assembly 22 to vibrate in the mounting cavity 11 to realize the function of motor vibration, and as a result, the sound production device 100 has a vibration tactile experience function. Further, the magnetic circuit system 32 of the loudspeaker module 3 is disposed on the side of the vibrator assembly 22 facing away from the coil 21 and is opposite the vibration system 31, so that on the one hand, the sound production function of the loudspeaker module 3 is realized by the cooperation of the vibration system 31 and the magnetic circuit system 32, and on the other hand, the coil 21 is used to drive the vibrator assembly 22 to drive the magnetic circuit system 32 to vibrate synchronously, and thus, the vibration module 2 and the loudspeaker module 3 of the sound production device 100 can work separately without interfering with each other, and as a result, the sound production device 100 has both audio experience and vibration tactile experience functions, thereby improving the user experience.

In an embodiment, the vibrator assembly 22 includes a vibrator body 221 and an elastic member 222. The vibrator body 221 is provided with a receiving groove 2211 corresponding to the coil 21, at least a part of the coil 21 is received in the receiving groove 2211, and a side of the vibrator body 221 facing away from the receiving groove 2211 is connected to the magnetic circuit system 32. One end of the elastic member 222 is connected to the vibrator body 221, and the other end of the elastic member 222 is connected to a cavity wall of the mounting cavity 11, so that the vibrator body 221 is suspended in the mounting cavity 11.

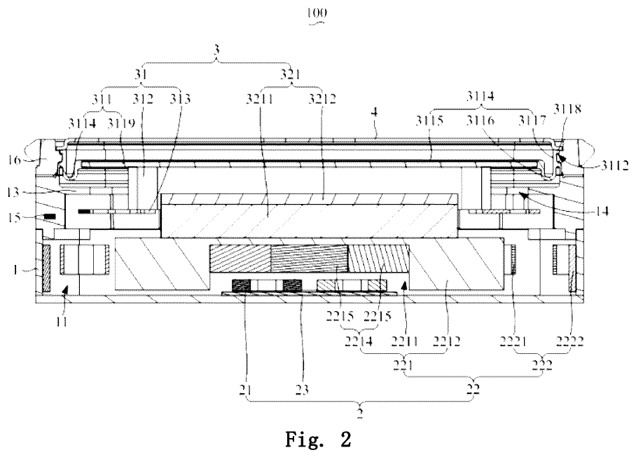

In the embodiment, as shown in FIGS. 2-4, the vibrator body 221 is suspended in the mounting cavity 11 by using the elastic member 222, that is, one end of the elastic member 222 is connected to the vibrator body 221, and the other end of the elastic member 222 is connected to the cavity wall of the mounting cavity 11. In this way, when the coil 21 drives the vibrator body 221 to drive the magnetic circuit system 32 to vibrate synchronously, the elastic member 222 provides an installation base for the vibrator body 221, and is also used to provide an elastic buffering force to avoid damaging other components of the sound production device 100 due to excessive vibration force of the vibrator body 221.

It will be understood that the elastic member 222 may be a component with elastic expansion and contraction function, for example, an elastic sheet, a spring, or other elastic components, which is not limited here. In the embodiment, the elastic member 222 is connected to a peripheral wall of the vibrator body 221. The elastic member 222 may be an integral structure or a plurality of separate structures, which is not limited here.

In the embodiment, a receiving groove 2211 is provided on the vibrator body 221 so that at least a part of the coil 21 is received in the receiving groove 2211. Thus, while avoiding the coil 21, the receiving groove 2211 makes the arrangement of the vibrator body 221 and the coil 21 more compact, effectively improving space utilization.

In an embodiment, the vibrator body 221 includes a counterweight base 2212 and a magnet assembly 2214. Opposite sides of the counterweight base 2212 are respectively connected to the elastic member 222, the counterweight base 2212 is provided with a hollow cavity 2213 corresponding to the coil 21, and the magnetic circuit system 32 is connected to a side of the counterweight base 2212 facing away from the coil 21. The magnet assembly 2214 is disposed in the hollow cavity 2213, and forms a receiving groove 2211 with the counterweight base 2212, and the coil 21 and the magnet assembly 2214 are disposed directly opposite each other.

In the embodiment, as shown in FIGS. 2-4, the counterweight base 2212 of the vibrator body 221 is not only used to install and fix the magnet assembly 2214, but also used to support and fix the magnetic circuit system 32, that is, the counterweight base 2212 is used to integrate the magnet assembly 2214 and the magnetic circuit system 32 into an integrated structure. It will be understood that by connecting the elastic member 222 to opposite sides of the counterweight base 2212 respectively, the counterweight base 2212 is installed and suspended in the mounting cavity through the elastic member 222.

It will be understood that by providing a hollow cavity 2213 on the counterweight base 2212, the hollow cavity 2213 can be utilized to facilitate the installation and fixing of the magnet assembly 2214, and the coil 21 and the magnet assembly 2214 are disposed directly opposite each other, In this way, after the current flows through the coil 21, they are in a magnetic field formed by the magnet assembly 2214, and as a result, the magnet assembly 2214 is driven to drive the counterweight base 2212 and the magnetic circuit system 32 to vibrate and move. In the embodiment, the elastic member 222 is also used to provide a directional force for the overall movement of the counterweight base 2212.

In the embodiment, the hollow cavity 2213 may be a groove structure, a through-slot structure, or a concave cavity structure, etc. that is disposed on the counterweight base 2212, but it is not limited thereto. It will be understood that the magnet assembly 2214 is disposed in the hollow cavity 2213 and forms a receiving groove 2211 with the counterweight base 2212. The counterweight base 2212 also plays the role of counterweight and load-bearing.

In an embodiment, the magnet assembly 2214 includes a plurality of magnet blocks 2215. It will be understood that the plurality of magnetic blocks 2215 are arranged side by side in the hollow cavity 2213 of the counterweight base 2212. The plurality of magnetic blocks 2215 may be connected as one by gluing, or may be arrange as an integrated structure by providing a connecting member, but it is not limited thereto.

Optionally, the arrangement direction of the plurality of magnetic blocks 2215 is the same as the vibration movement direction of the vibrator assembly 22.

In an embodiment, the number of the coil 21 may be one or more. Optionally, the number of the coil 21 is N, and the number of the magnetic blocks 2215 is N+1, where N≥1. It will be understood that such a configuration enables the magnet assembly 2214 to provide a sufficient magnetic field for the coil 21 to ensure that the coil 21 drives the vibrator body 221 to drive the magnetic circuit system 32 to vibrate and move. In the embodiment, the magnetization directions of two adjacent magnetic blocks 2215 among the plurality of magnetic blocks 2215 are opposite each other.

It will be understood that when a plurality of coils 21 are provided, the arrangement direction of the plurality of magnetic blocks 2215 is the same as the arrangement direction of the plurality of coils 21, so that the plurality of magnetic blocks 2215 are directly opposite the plurality of coils 21.

In an embodiment, the elastic member 222 includes two elastic sheets 2221 symmetrically disposed on opposite sides of the vibrator body 221, one end of each elastic sheet 2221 is connected to the vibrator body 221, and the other end thereof is connected to the cavity wall of the mounting cavity 11.

In the embodiment, as shown in FIGS. 2-4, by providing the elastic member 222 as elastic sheets 2221, on the one hand, the installation stability of the vibrator body 221 can be improved by using the elastic sheets 2221 and the vibrator body 221 can be ensured to be suspended in the mounting cavity 11, and on the other hand, the elastic sheets 2221 can also generate elastic buffering force and directional movement force on the vibration of the vibrator body 221.

It will be understood that the two elastic sheets 2221 are symmetrically arranged on two opposite sides of the vibrator body 221. A connection direction of the two elastic sheets 2221 is the same as the arrangement direction of the plurality of magnetic blocks 2215. That is, the coil 21 drives the magnet assembly 2214 to drive the counterweight base 2212 and the magnetic circuit system 32 to move in the same direction as the connection direction of the two elastic sheets 2221. In the embodiment, the coil 21 drives the magnet assembly 2214 to drive the counterweight base 2212 and the magnetic circuit system 32 to vibrate and move in a horizontal direction.

Optionally, the elastic sheet 2221 has a V-shape, a U-shape, a W-shape or a Y-shape. It will be understood that the elastic sheet 2221 may be made of metal material or plastic material, but it is not limited thereto. Optionally, the elastic sheets 2221 and the counterweight base 2212 are formed in an integrally formed structure, which can improve the structural strength and connection stability.

In an embodiment, an end of the elastic sheet 2221 away from the vibrator body 221 is connected to the cavity wall of the mounting cavity 11 through a connecting piece 2222. It will be understood that, as shown in FIGS. 2-4, by providing the connecting piece 2222, a contact area between the elastic sheet 2221 and the inner wall of the housing 1 is increased through the connecting piece 2222, so as to improve the connection stability.

In an embodiment, as shown in FIGS. 1 and 3-4, the vibration module 2 further includes a circuit board 24, one end of which extends into the mounting cavity 11 and is electrically connected to the coil 21. It will be understood that by providing the circuit board 24, and extending one end of the circuit board 24 into the mounting cavity 11 to be electrically connected to the coil 21, the circuit board 24 can be used to electrically connect an external circuit to the coil 21. Optionally, the circuit board 24 is a flexible circuit board, so that one end of the circuit board 24 can be adhered to a bottom wall in the mounting cavity 11 of the housing 1, and the other end of the circuit board 24 is bent and extended to the outside of the housing 1 to achieve conduction.

In an embodiment, the vibration system 31 includes a diaphragm assembly 311 and a voice coil 312 connected to the diaphragm assembly 311, and a periphery of the diaphragm assembly 311 is connected to the housing 1; the magnetic circuit system 32 includes a central magnetic circuit part 321 and a side magnetic circuit part 322 disposed on the vibrator assembly 22, the side magnetic circuit part 322 is arranged on the outside of the central magnetic circuit part 321, and is spaced from the central magnetic circuit part 321 to form a magnetic gap 323, and an end of the voice coil 312 away from the diaphragm assembly 311 is suspended in the magnetic gap 323.

In the embodiment, as shown in FIGS. 2-4, the periphery of the diaphragm assembly 311 of the vibration system 31 is connected to the housing 1 to achieve fixing and installation of the vibration system 31. One end of the voice coil 312 is connected to the diaphragm assembly 311, and the other end of the voice coil 312 is suspended in the magnetic gap 323 of the magnetic circuit system 32, so that after the current flows through the coil 21, the voice coil 312 converts electrical energy into mechanical vibration in the magnetic field formed by the central magnetic circuit part 321 and the side magnetic circuit part 322 of the magnetic circuit system 32, so that the voice coil 312 drives the diaphragm assembly 311 to vibrate and produce sound, thereby realizing the conversion of mechanical energy into sound signals.

It will be understood that in the vibration system 31, the voice coil 312 drives the diaphragm assembly 311 to vibrate in a vertical direction, while the coil 21 of the vibration module 2 drives the magnet assembly 2214 to drive the counterweight base 2212 and the magnetic circuit system 32 to vibrate and move in the horizontal direction, so that the vibration module 2 and the loudspeaker module 3 in the sound production device 100 can work separately without interfering with each other.

It should be noted that the side magnetic circuit part 322 may be an integral annular structure, and the central magnetic circuit part 321 is an annular inner portion of the side magnetic circuit part 322 and is spaced from the side magnetic circuit part 322 to form a magnetic gap 323. Of course, in other embodiments, the side magnetic circuit part 322 may be a plurality of split structural components, and the plurality of split structural components are arranged at intervals around the central magnetic circuit part 321, but it is not limited thereto.

In the embodiment, the side magnetic circuit part 322 includes two side magnetic circuit parts 322, the two side magnetic circuit parts 322 are arranged on a longer axis side on both sides of the central magnetic circuit part 321, and a direction in which the magnetic gap 323 formed by the two side magnetic circuit parts 322 and the central magnetic circuit part 321 extends is consistent with the vibration movement direction of the vibrator assembly 22. It will be understood that magnetic circuit system 32 has a longer axis and a shorter axis, the two side magnetic circuit parts 322 are arranged on two longer axis sides of the magnetic circuit system 32 and are located on opposite sides of the central magnetic circuit part 321, and the extension direction of the magnetic gap 323 is the longer axis direction of the magnetic circuit system 32, and at this time, the extension direction of the magnetic gap 323 is consistent with the vibration movement direction of the vibrator assembly 22.

In order to prevent the magnetic circuit system 32 from colliding with the voice coil 312 when the coil 21 drives the magnet assembly 2214 to drive the counterweight base 2212 and the magnetic circuit system 32 to vibrate and move in the horizontal direction, the side magnetic circuit part 322 of the magnetic circuit system 32 is only arranged in the longer axis direction but not in the shorter axis direction.

It will be understood that in order to avoid the voice coil 312 from colliding with the central magnetic circuit part 321, the voice coil 312 extends in an annular shape along the longer axis direction, that is, to provide an escape space for the central magnetic circuit part 321 to move with the counterweight base 2212.

In an embodiment, as shown in FIGS. 2-4, the central magnetic circuit part 321 includes a central magnet 3211 and a central washer 3212 disposed on the vibrator assembly 22, and the central washer 3212 is arranged on a side of the central magnet 3211 facing away from the vibrator assembly 22; the side magnetic circuit part 322 includes a side magnet 3221 and a side washer 3222 disposed on the vibrator assembly 22, the side washer 3222 is arranged on a side of the side magnet 3221 facing away from the vibrator assembly 22, and the magnetization direction of the central magnet 3211 is opposite the magnetization direction of the side magnet 3221.

In the embodiment, the central magnet 3211 of the central magnetic circuit part 321 and the side magnet 3221 of the side magnetic circuit part 322 are both fixed on the counterweight base 2212 of the vibrator assembly 22, and are spaced to form a magnetic gap 323, and the central washer 3212 and the side washer 3222 are respectively stacked with the central magnet 3211 and the side magnet 3221, and are arranged opposite each other, so that the voice coil 312 generates a very high driving force in the magnetic gap 323, driving the diaphragm assembly 311 of the vibration system 31 to move.

It will be understood that a shorter axis area of the voice coil 312 is far away from the magnetic field to avoid vibration of the central magnetic circuit part 321 coupling with the counterweight base 2212 in the longer axis direction. The shorter axis area of the voice coil 312 far away from the magnetic field accounts for less than 15%, and thus, BL loss is controlled within 15%. It should be noted that a washer may be added at the bottom of the central magnet 3211 and the side magnet 3221 to increase BL. The longer axis of the voice coil 312 is as close to the central magnet 3211 as possible to improve the utilization rate of the magnetic circuit.

In an embodiment, the housing 1 includes a middle frame 16 arranged on a periphery of the diaphragm assembly 311, the diaphragm assembly 311 includes a diaphragm 3114 and a reinforcing member 3119. The diaphragm 3114 includes a central portion 3115, a folded ring portion 3116 arranged around the central portion 3115, and a fixing portion 3117 connected to the outside of the folded ring portion 3116. The fixing portion 3117 is connected to an inner wall of the middle frame 16, and the reinforcing member 3119 is arranged on the central portion 3115. The voice coil 312 is connected to the central portion 3115 or the reinforcing member 3119.

In the embodiment, as shown in FIGS. 1-4 and 6, the middle frame 16 is provided on the periphery of the diaphragm assembly 311, so that on the one hand, the diaphragm assembly 311 is installed and fixed by the middle frame 16, and on the other hand, the middle frame 16 is conveniently sealed and connected to the housing 1. Optionally, the diaphragm 3114 and the middle frame 16 are integrally injection molded, which can improve the connection strength and sealing performance between the diaphragm assembly 311 and the middle frame 16.

It will be understood that by providing a reinforcing member 3119 on the central portion 3115 of the diaphragm 3114, the reinforcing member 3119 can be used to strengthen the structural strength of the central portion 3115 of the diaphragm 3114. Optionally, the diaphragm 3114 and the reinforcing member 3119 are integrally injection molded. In the embodiment, the central portion 3115 of the diaphragm 3114 may be a hollow structure or a flat plate structure, but it is not limited thereto.

Optionally, the reinforcing member 3119 and the central portion 3115 are integrally formed by hot pressing, so that the reliability and durability of the diaphragm 3114 can be improved.

In the embodiment, the folded ring portion 3116 of the diaphragm 3114 may be selected to be a U-shaped structure, and the folded ring portion 3116 of the diaphragm 3114 has elastic recovery capability. Such an arrangement provides greater compliance while occupying a very small vibration radiation surface, effectively increasing the vibration sound production area. It will be understood that the fixing portion 3117 of the diaphragm 3114 is arranged vertically upward along an outer side of the folded ring portion 3116. Such an arrangement can increase a contact area between the fixing portion 3117 and the inner wall of the middle frame 16, improve the connection stability, and increase the effective sound production area.

Optionally, the reinforcing member 3119 may be disposed on an upper surface or a lower surface of the central portion 3115. In the embodiment, the reinforcing member 3119 is connected to the lower surface of the central portion 3115, and the voice coil 312 is connected to the reinforcing member 3119.

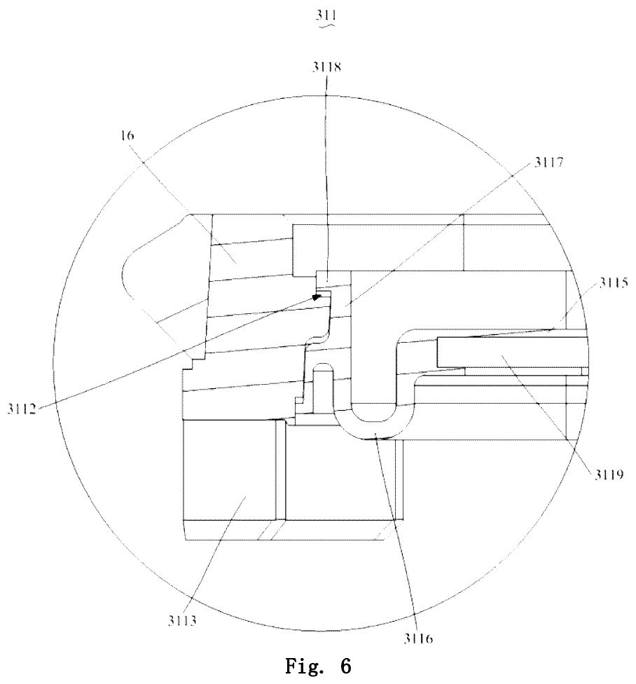

In an embodiment, as shown in FIG. 6, one of the fixing portion 3117 or the inner wall of the middle frame 16 is provided with a limiting boss 3118, and the other thereof is provided with a limiting groove 3112, and the limiting boss 3118 is limited in the limiting groove 3112.

In the embodiment, by providing a limiting boss 3118 and a limiting groove 3112 on the fixing portion 3117 and the middle frame 16 respectively and arranging the limiting boss 3118 in the limiting groove 3112, the connection stability and sealing effect between the fixing portion 3117 and the middle frame 16 can be improved. It will be understood that the limiting boss 3118 is provided on the fixing portion 3117 and the limiting groove 3112 is provided on the inner wall of the middle frame 16; or, the limiting groove 3112 is provided on the fixing portion 3117 and the limiting boss 3118 is provided on the inner wall of the middle frame 16; or, the limiting boss 3118 and the limiting groove 3112 are both provided on the fixing portion 3117 and the inner wall of the middle frame 16; however, it is not limited thereto.

In order to achieve installation and positioning of the diaphragm assembly 311, in an embodiment, one of the middle frame 16 or the housing 1 is provided with a limiting slot 12, the other thereof is provided with a limiting post 3113, and the limiting post 3113 is limited in the limiting slot 12.

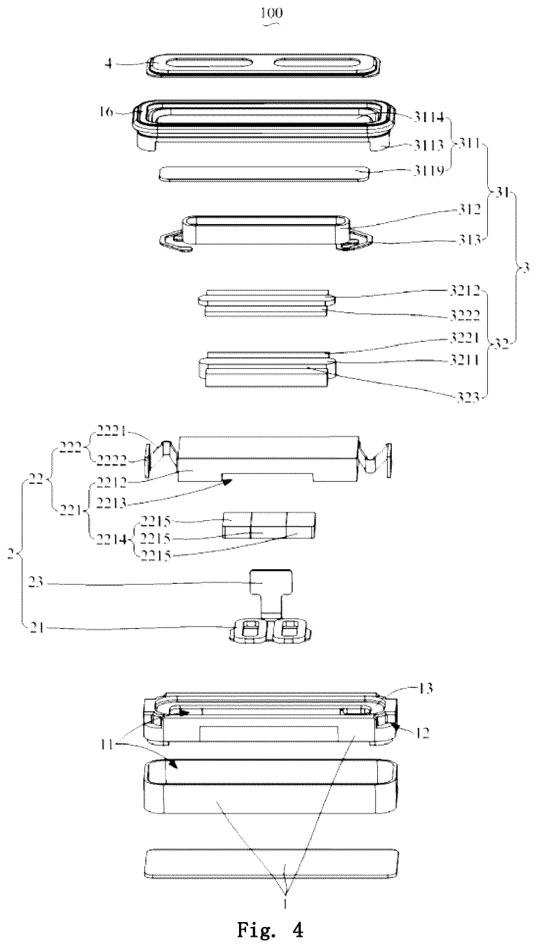

It will be understood that, as shown in FIG. 4, by respectively providing a limiting post 3113 and a limiting slot 12 on the middle frame 16 and the housing 1 and arranging the limiting post 3113 in the limiting slot 12, the middle frame 16 can be mounted on the housing 1 to achieve positioning and installation.

In an embodiment, as shown in FIGS. 1-4, the sound production device 100 further includes a front cover 4, which is disposed on a side of the diaphragm 3114 facing away from the voice coil 312 and is connected to the middle frame 16. It will be understood that by providing the front cover 4, the diaphragm 3114 of the diaphragm assembly 311 is protected by the front cover 4.

In an embodiment, a limiting stop 13 is protruded from the inner wall of the housing 1, and the limiting stop 13 is directly opposite an edge of the reinforcing member 3119, that is, a vertical projection of the edge of the limiting stop 13 partially overlaps with a vertical projection of the reinforcing member 3119. The limiting stop 13 surrounds to form a via opening 14, and the voice coil 312 passes through the via opening 14 to be suspended in the magnetic gap 323.

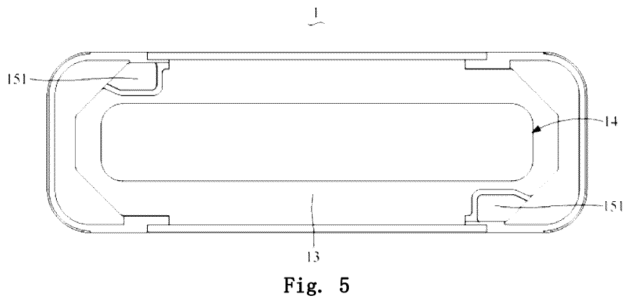

In the embodiment, as shown in FIGS. 2-5, when the sound production device 100 is applied to a wearable device, when the user goes into water or swims, the diaphragm 3114 of the diaphragm assembly 311 is affected by the water pressure, and accordingly, a limiting stop 13 may be provided to limit the movement of the central portion 3115 of the diaphragm 3114, thereby effectively avoiding problems such as tearing of the folded ring portion 3116 of the diaphragm 3114. At the same time, the limiting stop 13 also has a good waterproof effect, so that the waterproof level of the sound production device 100 is 5 ATM or greater.

Of course, the provision of the limiting stop 13 is also beneficial to limiting the rotation of the vibrator body 221 during the vibration in a horizontal plane, thereby avoiding collision between the magnetic circuit system 32 and the voice coil 312.

In an embodiment, the vibration system 31 further includes a centering slice 313, one end of the centering slice 313 is connected to an end of the voice coil 312 away from the diaphragm 3114, and the other end of the centering slice 313 is connected to the housing 1.

In the embodiment, as shown in FIGS. 2 and 4, by providing a centering slice 313, on the one hand, the centering slice 313 is used to effectively prevent polarization and swing of the voice coil 312, and on the other hand, the centering slice 313 is used to achieve conduction between the voice coil 312 and the external circuit.

It will be understood that the centering slice 313 may be an integral structure, or may be composed of two or four separate structures. In the embodiment, the centering slice 313 includes two centering slices 313. The two centering slices 313 are disposed in the shorter axis direction and are respectively connected to the shorter axis of the voice coil 312.

In an embodiment, a conductive metal sheet 15 is provided in the housing 1, one end of the conductive metal sheet 15 is provided with an inner pad 151, which is exposed to a side of the limiting stop 13 facing away from the folded ring portion 3116 and soldered to the centering slice 313, and the other end of the conductive metal sheet 15 is provided with an outer pad 152, which is exposed to an outer wall of the housing 1 and is connected to the external circuit.

In the embodiment, as shown in FIGS. 1-2 and 5, the conductive metal sheet 15 is arranged inside the housing 1, an inner pad 151 is provided at one end of the conductive metal sheet 15, and an outer pad 152 is provided at the other end of the conductive metal sheet 15. The inner pad 151 is arranged on a side of the limiting stop 13 facing away from the folded ring portion 3116, and can be conveniently soldered to the centering slice 313. The outer pad 152 is arranged on the outer wall of the housing 1 for connecting to an external circuit, thereby facilitating guiding the external circuit to the voice coil 312 through the conductive metal sheet 15 and the centering slice 313.

The present disclosure also provides an electronic apparatus, including an apparatus housing and the above-mentioned sound production device 100, wherein the sound production device 100 is disposed in the apparatus housing. The specific structure of the sound production device 100 refers to the aforementioned embodiments. Since the electronic apparatus adopts all the technical solutions of all the aforementioned embodiments, it has at least all the beneficial effects brought by the technical solutions of the aforementioned embodiments, which will not be described one by one here.

It will be understood that the electronic apparatus may be a mobile phone, a wearable device, etc., but it is not limited thereto. The apparatus housing may be a housing of an electronic apparatus, a housing of a wearable device, etc., but it is not limited thereto.

The above descriptions are only optional embodiments of the present disclosure, and are not intended to limit the patent scope of the present disclosure. All equivalent structural changes made using the contents of the present specification and accompanying drawings, or directly/indirectly applications in other related technical fields, are included in in the patent protection scope of the present disclosure.

1. A sound production device, comprising:
a housing provided with a mounting cavity;
a vibration module comprising a coil and a vibrator assembly which are provided in the mounting cavity, wherein the vibrator assembly is suspended in the mounting cavity and is arranged opposite the coil; and
a loudspeaker module comprising a vibration system and a magnetic circuit system which are provided in the mounting cavity, wherein the magnetic circuit system is provided on a side of the vibrator assembly facing away from the coil and is opposite the vibration system,
wherein the coil drives the vibrator assembly to drive the magnetic circuit system to vibrate synchronously.

2. The sound production device of claim 1, wherein the vibrator assembly comprises:
a vibrator body provided with a receiving groove corresponding to the coil, wherein at least a part of the coil is received in the receiving groove, and a side of the vibrator body facing away from the receiving groove is connected to the magnetic circuit system; and
an elastic member, one end of which is connected to the vibrator body, and the other end of which is connected to a cavity wall of the mounting cavity, so that the vibrator body is suspended in the mounting cavity.

3. The sound production device of claim 2, wherein the vibrator body comprises:
a counterweight base, opposite sides of which are respectively connected to the elastic member, wherein the counterweight base is provided with a hollow cavity corresponding to the coil, and the magnetic circuit system is connected to a side of the counterweight base facing away from the coil; and
a magnet assembly disposed in the hollow cavity and forming the receiving groove with the counterweight base, wherein the coil and the magnet assembly are disposed opposite each other.

4. The sound production device of claim 2, wherein the elastic member comprises two elastic sheets, wherein the two elastic sheets are symmetrically arranged on opposite sides of the vibrator body, one end of each elastic sheet is connected to the vibrator body, and the other end thereof is connected to the cavity wall of the mounting cavity.

5. The sound production device of claim 4, wherein the elastic sheet has a V-shape, a U-shape, a W-shape or a Y-shape; and/or,
an end of the elastic sheet away from the vibrator body is connected to the cavity wall of the mounting cavity through a connecting piece.

6. The sound production device of claim 1, wherein the vibration system comprises a diaphragm assembly and a voice coil connected to the diaphragm assembly, and a periphery of the diaphragm assembly is connected to the housing; and
wherein the magnetic circuit system comprises a central magnetic circuit part and a side magnetic circuit part disposed on the vibrator assembly, wherein the side magnetic circuit part is arranged on the outside of the central magnetic circuit part and is spaced from the central magnetic circuit part to form a magnetic gap, and an end of the voice coil away from the diaphragm assembly is suspended in the magnetic gap.

7. The sound production device of claim 6, wherein the side magnetic circuit part comprises two side magnetic circuit parts, wherein the two side magnetic circuit parts are arranged on a longer axis side on both sides of the central magnetic circuit part, and a direction in which the magnetic gap formed by the two side magnetic circuit parts and the central magnetic circuit part extends is consistent with a vibration movement direction of the vibrator assembly; and/or,
wherein the central magnetic circuit part comprises a central magnet and a central washer arranged on the vibrator assembly, wherein the central washer is arranged on a side of the central magnet facing away from the vibrator assembly, and wherein the side magnetic circuit part comprises a side magnet and a side washer arranged on the vibrator assembly, wherein the side washer is arranged on a side of the side magnet facing away from the vibrator assembly, and wherein a magnetization direction of the central magnet is opposite a magnetization direction of the side magnet.

8. The sound production device of claim 6, wherein the housing comprises a middle frame arranged at a periphery of the diaphragm assembly, and the diaphragm assembly comprises:
a diaphragm comprising a central portion, a folded ring portion arranged around the central portion, and a fixing portion connected to the outside of the folded ring portion, the fixing portion being connected to an inner wall of the middle frame; and
a reinforcing member disposed on the central portion,
wherein the voice coil is connected to the central portion or the reinforcing member.

9. The sound production device of claim 8, wherein the diaphragm and the reinforcing member are integrally injection molded; and/or,
the diaphragm and the middle frame are integrally injection molded; and/or,
the reinforcing member and the central portion are integrally formed by hot pressing; and/or,
one of the fixing portion or the inner wall of the middle frame is provided with a limiting boss, and the other thereof is provided with a limiting groove, wherein the limiting boss is limited in the limiting groove.

10. The sound production device of claim 8, wherein the vibration system further comprises a centering slice, wherein one end of the centering slice is connected to an end of the voice coil away from the diaphragm, and the other end of the centering slice is connected to the housing.

11. The sound production device of claim 10, wherein a limiting stop is protruded from an inner wall of the housing, the limiting stop is directly opposite an edge of the reinforcing member, the limiting stop surrounds to form a via opening, and the voice coil passes through the via opening to be suspended in the magnetic gap.

12. The sound production device of claim 11, wherein a conductive metal sheet is provided in the housing, one end of the conductive metal sheet is provided with an inner pad, which is exposed to a side of the limiting stop facing away from the folded ring portion and soldered to the centering slice, and the other end of the conductive metal sheet is provided with an outer pad, which is exposed to an outer wall of the housing to be connected to an external circuit.

13. An electronic apparatus, comprising an apparatus housing and the sound production device of claim 1, wherein the sound production device is disposed in the apparatus housing.
